(19) United States
(12) Patent Application Publication
(10) Pub. No.: US 2024/0273341 A1
(43) Pub. Date: Aug. 15, 2024

(54) METHOD, DEVICE, AND STORAGE MEDIUM FOR DECENTRALIZED OPTIMAL CONTROL FOR LARGE-SCALE MULTIAGENT SYSTEMS

(71) Applicant: Intelligent Fusion Technology, Inc., Germantown, MD (US)

(72) Inventors: Shawon DEY, Reno, NV (US); Dan SHEN, Germantown, MD (US); Zola DONOVAN, Rome, NY (US); Genshe CHEN, Germantown, MD (US); Hao XU, Reno, NV (US); Erik BLASCH, Arlington, VA (US)

(21) Appl. No.: 18/163,860

(22) Filed: Feb. 2, 2023

(51) Int. Cl. G06N 3/045; G06N 3/08

(52) U.S. Cl. CPC G06N 3/045; G06N 3/08

(57) ABSTRACT

The present disclosure provides a method, a device, and a storage medium for decentralized optimal control for a large-scale multi-agent system. The method includes initializing errors to obtain an initialized error of each of an actor NN, a critic NN and a mass NN; initializing error thresholds to obtain an initialized error threshold of each of the actor NN, the critic NN and the mass NN; and if the initialized error of each of the actor NN, the critic NN and the mass NN is greater than or equal to a corresponding initialized error threshold, calculating weights of each of the actor NN, the critic NN and the mass NN, and updating the actor NN, the critic NN, and the mass NN; and calculating errors of each of the actor NN, the critic NN and the mass NN, and updating the actor NN, the critic NN, and the mass NN.

### GOVERNMENT RIGHTS

The present disclosure was made with Government support under Contract No. FA8750-22-C-1000, awarded by the United States Air Force Research Laboratory. The U.S. Government has certain rights in the present disclosure.

### FIELD OF THE DISCLOSURE

The present disclosure generally relates to the field of hierarchical heterogeneous planning and scheduling technology and, more particularly, relates to a method, a device, and a storage medium for decentralized optimal control for large-scale multi-agent systems.

### BACKGROUND

In recent years, large-scale multi-agent systems (LS-MAS) have attracted significant interest from both research societies and industrial communities due to its capability of upgrading conventional multi-agent system performance by using its diversity gain. For instance, the tracking control problem in the LS-MAS has been studied. However, It is extremely difficult to directly utilize conventional control into LS-MAS due to three challenges. The first challenge is notorious “curse of dimensionality”. Since conventional cooperative control needs each agent to know other agents' states, the computational complexity of distributed control is exponentially increased along with increased number of agents. The second challenge is lacking a realistic reliable communication network that can timely support information exchange among LS-MAS. Due to the limitation of communication capability in practice, conventional distributed cooperative control techniques are extremely difficult to be applied. The last challenge is that the constraints from physical system limitation and practical environment may cause difficulty in LS-MAS optimal control design. Therefore, there is a need to overcome these challenges simultaneously and lead to an intelligent, reliable and applicable control for LS-MAS.

### BRIEF SUMMARY OF THE DISCLOSURE

One aspect or embodiment of the present disclosure provides a method for decentralized optimal control for a large-scale multi-agent system. The large-scale multi-agent system includes multiple agents, and each agent includes three neural networks (NNs) including an actor NN, a critic NN, and a mass NN. The method includes initializing errors to obtain an initialized error of the actor NN, an initialized error of the critic NN, and an initialized error of the mass NN; initializing error thresholds to obtain an initialized error threshold of the actor NN, an initialized error threshold of the critic NN, and an initialized error threshold of the mass NN; if the initialized error of the actor NN is greater than or equal to the initialized error threshold of the actor NN, if the initialized error of the critic NN is greater than or equal to the initialized error threshold of the critic NN, and if the initialized error of the mass NN is greater than or equal to the initialized error threshold of the mass NN: calculating NN weights of the actor NN, the critic NN, and the mass NN, respectively; and updating the actor NN, the critic NN, and the mass NN using corresponding calculated NN weights, respectively; and calculating NN errors of the actor NN, the critic NN, and the mass NN, respectively; and updating the actor NN, the critic NN, and the mass NN using corresponding calculated NN errors, respectively.

Another aspect or embodiment of the present disclosure provides a device for decentralized optimal control for a large-scale multi-agent system. The large-scale multi-agent system includes multiple agents, and each agent includes three neural networks (NNs) including an actor NN, a critic NN, and a mass NN. The device includes a memory, configured to store program instructions for performing a method for decentralized optimal control for the large-scale multi-agent system; and a processor, coupled with the memory and, when executing the program instructions, configured for: initializing errors to obtain an initialized error of the actor NN, an initialized error of the critic NN, and an initialized error of the mass NN; initializing error thresholds to obtain an initialized error threshold of the actor NN, an initialized error threshold of the critic NN, and an initialized error threshold of the mass NN; if the initialized error of the actor NN is greater than or equal to the initialized error threshold of the actor NN, if the initialized error of the critic NN is greater than or equal to the initialized error threshold of the critic NN, and if the initialized error of the mass NN is greater than or equal to the initialized error threshold of the mass NN: calculating NN weights of the actor NN, the critic NN, and the mass NN, respectively; and updating the actor NN, the critic NN, and the mass NN using corresponding calculated NN weights, respectively; and calculating NN errors of the actor NN, the critic NN, and the mass NN, respectively; and updating the actor NN, the critic NN, and the mass NN using corresponding calculated NN errors, respectively.

Another aspect or embodiment of the present disclosure provides a non-transitory computer-readable storage medium, containing program instructions for, when being executed by a processor, performing a method for decentralized optimal control for a large-scale multi-agent system. The large-scale multi-agent system includes multiple agents, and each agent includes three neural networks (NNs) including an actor NN, a critic NN, and a mass NN. The method includes initializing errors to obtain an initialized error of the actor NN, an initialized error of the critic NN, and an initialized error of the mass NN; initializing error thresholds to obtain an initialized error threshold of the actor NN, an initialized error threshold of the critic NN, and an initialized error threshold of the mass NN; if the initialized error of the actor NN is greater than or equal to the initialized error threshold of the actor NN, if the initialized error of the critic NN is greater than or equal to the initialized error threshold of the critic NN, and if the initialized error of the mass NN is greater than or equal to the initialized error threshold of the mass NN: calculating NN weights of the actor NN, the critic NN, and the mass NN, respectively; and updating the actor NN, the critic NN, and the mass NN using corresponding calculated NN weights, respectively; and calculating NN errors of the actor NN, the critic NN, and the mass NN, respectively; and updating the actor NN, the critic NN, and the mass NN using corresponding calculated NN errors, respectively.

Other aspects or embodiments of the present disclosure may be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 depicts a flowchart of an exemplary method for decentralized optimal control for a large-scale multi-agent system according to various disclosed embodiments of the present disclosure.

FIG. 2 depicts an exemplary barrier-actor-critic-mass (BACM) algorithm according to various disclosed embodiments of the present disclosure.

FIG. 3 depicts an exemplary structure of a barrier-actor-critic-mass system according to various disclosed embodiments of the present disclosure.

FIG. 4 depicts an exemplary overall trajectory schematic according to various disclosed embodiments of the present disclosure.

FIG. 5 depicts an exemplary tracking error plot of all agents in an x axis according to various disclosed embodiments of the present disclosure.

FIG. 6 depicts an exemplary tracking error plot of all agents in a y axis according to various disclosed embodiments of the present disclosure.

FIG. 7 depicts an exemplary HJB (Hamiltonian-Jacobi-Bellman) equation error plot according to various disclosed embodiments of the present disclosure.

FIG. 8 depicts an exemplary FPK (Fokker-Planck-Kolmogorov) equation error plot according to various disclosed embodiments of the present disclosure.

### DETAILED DESCRIPTION

References may be made in detail to exemplary embodiments of the disclosure, which may be illustrated in the accompanying drawings. Wherever possible, same reference numbers may be used throughout the accompanying drawings to refer to same or similar parts.

Mean field game theory (MFG) may be adopted to address the “curse of dimensionality” in LS-MAS. In MFG, individual agents may use a probability density function (PDF) (i.e. “mass”) of all agents to observe the behavior of entire population without requiring their states and control inputs. Then, infinity players' non-cooperative game may be shifted into a two-players game that includes a single agent versus entire population. Meanwhile, practical physical system limitations as well as complex environment may cause constraints into the control design for LS-MAS. For example, both state and density constraints may be considered in MFG based control for LS-MAS, respectively. To better integrate those constraints into the MFG-based LS-MAS optimal control problem formulation, barrier function may be adopted for handling individual agent state constraint and mass function's density constraint. With the barrier function and MFG, the constrained LS-MAS optimal control problem may be formulated. However, to obtain optimal control, a pair of forward and backward partial differential equation (PDE), called Fokker-Planck-Kolmogorov (FPK) equation and Hamiltonian-Jacobi-Bellman (HJB) equation, may need to be solved. It is extremely difficult and even impossible to directly solve these PDEs since these two PDEs are closely coupled with each other. To address such difficulty, adaptive dynamic programming and reinforcement learning technique may be adopted. Furthermore, a barrier-actor-critic-mass (BACM) learning algorithm may be developed with mass NN (neural network) for learning behaviors of large population via estimating the solution of FPK equation with barrier function, critic NN for obtaining optimal cost function by learning the solution of the HJB equation with barrier function, and actor NN for solving decentralized optimal tracking control based on the information provided by the mass NN and the critic NN. The key contributions of such configuration may be the following: the boundary and density constraints may be integrated into conventional MFG based LS-MAS optimization through a barrier function based system transformation; and the barrier-actor-critic-mass algorithm may be developed to solve the constrained HJB and FPK equations simultaneously and further obtain the optimal control for LS-MAS in real-time.

According to various embodiments of the present disclosure, LS-MAS tracking optimal control is described hereinafter. N may represent the number of homogeneous agents moving in a l dimensional configuration space, which is enclosed by an upper and lower boundary. An agent i may be controlled by the stochastic differential equation with their states being constrained as follows:

$${dx}_{i} = [ f ( {x}_{i} ) + g ( {x}_{i} ) {u}_{i} ] dt + \sqrt{2 v} {dB}_{i} \qquad ( 1 )$$

where f(xᵢ) and g(xᵢ) may be nonlinear functions, xᵢ may be an agent state which includes the position and velocity of the agent, uᵢ may be a control input, Bᵢ may be standard Brownian motion which represents the process noise; and v may be a non-negative parameter.

A predefined time varying trajectory xᵣ(t) may be given to all agents, where t is time. The objective of individual agent may be to track the reference trajectory by minimizing the tracking error which is defined as the following:

$${\tilde{x}}_{i} ( t ) = {x}_{i} ( t ) - {x}_{r} ( t ) \qquad ( 2 )$$

Moreover, the tracking error dynamics may be derived as follows:

$$\begin{matrix}d {\tilde{x}}_{i} ( t ) = {dx}_{i} ( t ) - {dx}_{r} ( t ) \\ = [ f ( {x}_{i} ) + g ( {x}_{i} ) {u}_{i} - \frac{\text{?}}{dt} ] dt + \sqrt{2 υ} {dB}_{i} \\ = [ {f}^{′} ( {\tilde{x}}_{i} ) + {g}^{′} ( {\tilde{x}}_{i} ) {u}_{i} ] dt + \sqrt{2 υ} {dB}_{i}\end{matrix} \qquad ( 3 )$$

$$where ,$$

$${f}^{′} ( {\tilde{x}}_{i} ) = f ( {\tilde{x}}_{i} + {x}_{r} ) - ( {dx}_{r} / dt )$$

$$and$$

$${g}^{′} ( {\tilde{x}}_{i} ) = g ( {\tilde{x}}_{i} + {x}_{r} )$$

$$\text{?} \text{indicates text missing or illegible when filed}$$

The optimal objective of each agent may be to track the reference trajectory by minimizing the following cost function:

$$\text{?} ( {\tilde{x}}_{i} , m ) = E \{ {\int }_{0}^{∞} [ L ( {\tilde{x}}_{i} , {u}_{i} ) + C ( {\tilde{x}}_{i} , m ) ] dt \} \qquad ( 4 )$$

$$\text{?} \text{indicates text missing or illegible when filed}$$

where m(\tilde{x}ᵢ, t) may denote the probability density function (mass) of the population's tracking error at time t. Also, C(\tilde{x}ᵢ, m) may be the mean field coupling function which represents the interaction between agent i and the whole population of other agents. Since the dimension of the PDF and each agent state are same, the mean field coupling function can greatly reduce the computational complexity problem. Moreover, L(\tilde{x}ᵢ, uᵢ)=∥\tilde{x}ᵢ∥+∥uᵢ∥_{R}², where Q and R have compatible dimensions.

Next, a barrier-function based system transformation may be applied to the original system to ensure both the tracking error state and density constraints. Let the Barrier function B(.): [symbol] → [symbol] is defined on (l_{\tilde{x},i}), u_{\tilde{x},i}), then the tracking error state \tilde{x}ᵢ of the system may be represented as follows:

$${s}_{i} = {B}_{i} ( {\tilde{x}}_{i} ; {l}_{\tilde{x} , i} , {u}_{\tilde{x} , i} ) = ln \frac{{u}_{\tilde{x} , i} ( {l}_{\tilde{x} , i} - {\tilde{x}}_{i} )}{{l}_{\tilde{x} , i} ( {u}_{\tilde{x} , i} - {\tilde{x}}_{i} )} \qquad ( 5 )$$

where l_{\tilde{x},i} and u_{\tilde{x},i} may satisfy l_{\tilde{x},i}<\tilde{x}i<u_{\tilde{x},i} and sᵢ may be the tracking error state of the transformed system. Also, the Barrier function may be invertible on interval (l_{\tilde{x},i}, u_{\tilde{x},i}), for example:

$${\tilde{x}}_{i} = {B}_{i}^{- 1} ( {s}_{i} ; {l}_{\tilde{x} , i} , {u}_{\tilde{x} , i} ) = {l}_{\tilde{x} , i} , {u}_{\tilde{x} , i} \frac{\text{?} - \text{?}}{{l}_{\tilde{x} , i} \text{?} - {u}_{\tilde{x} , i} \text{?}} \qquad ( 6 )$$

$$\text{?} \text{indicates text missing or illegible when filed}$$

Similarly, barrier function may be generated for ensuring density constraint as follows:

$$ρ = {B}_{m} ( m ; {ρ}_{1} , {p}_{2} ) = ln \frac{{ρ}_{2} ( {ρ}_{1} - m ( {\tilde{x}}_{i} , t ) )}{{ρ}_{1} ( {ρ}_{2} - m ( {\tilde{x}}_{i} , t ) )} \qquad ( 7 )$$

where ρ₁ and ρ₂ may be two constants satisfying ρ₁<ρ₂. The inverse of the barrier function may be represented as follows:

$$m = {B}_{m}^{- 1} ( ρ ; {ρ}_{1} , {ρ}_{2} ) = {ρ}_{1} {ρ}_{2} \frac{\text{?} - \text{?}}{{ρ}_{1} \text{?} - {ρ}_{2} \text{?}} \qquad ( 8 )$$

$$\text{?} \text{indicates text missing or illegible when filed}$$

where ρ may be the density of the transformed system.

In one embodiment of the present disclosure, the barrier functions B(.) may take finite value when the arguments are within above defined region and approach to infinity as the state and density approach the boundary of the defined region, respectively.

The dynamics of the transformed state sᵢ may be obtained by using following chain rule:

$$\begin{matrix}{ds}_{i} = \frac{\frac{d {\tilde{x}}_{i}}{dt}}{\frac{d {\tilde{x}}_{i}}{{ds}_{i}}} dt \\ = \frac{[ {f}^{′} ( {\tilde{x}}_{i} ) + {g}^{′} ( {\tilde{x}}_{i} ) {u}_{i} ] dt}{\frac{d ( \text{?} \frac{\text{?}}{\text{?}} )}{{ds}_{i}}} \\ = [ {f}^{′} ( {\tilde{x}}_{i} ) + {g}^{′} ( {\tilde{x}}_{i} ) {u}_{i} ] \frac{{u}_{\tilde{x} , i}^{2} \text{?} - {l}_{\tilde{x} , i} {u}_{\tilde{x} , i} + {l}_{\tilde{x} , i}^{2} \text{?}}{{u}_{\tilde{x} , i} {l}_{\tilde{x} , i}^{2} - {l}_{\tilde{x} , i} {u}_{\tilde{x} , i}^{2}} dt \\ = [ F ( {s}_{i} ) + G ( {s}_{i} ) {u}_{i} ] dt + \sqrt{2 υ} {dB}_{i}\end{matrix} \qquad ( 9 )$$

$$where$$

$$F ( {s}_{i} ) = f ( {\tilde{x}}_{i} ) \frac{\text{?}}{\text{?}}$$

$$and$$

$$G ( {s}_{i} ) = g ( {\tilde{x}}_{i} ) \frac{\text{?}}{\text{?}}$$

$$\text{?} \text{indicates text missing or illegible when filed}$$

F(sᵢ) may be Lipschitz, and there may exist a constant a_{f} such that for sᵢ∈Ω, ∥F(sᵢ)∥≤a_{f}∥sᵢ∥, where Ω may be a compact set containing the origin. In addition, G(sᵢ) may be bounded on Ω, i.e., there may exist a constant a_{g} such that ∥(sᵢ)∥≤a_{g}. Moreover, the system in equation (1) may be controllable over the compact set Ω.

Next, a new cost function of the transformed state may be represented as follows:

$${V}_{i} ( {s}_{i} , ρ ) = E {\int }_{0}^{∞} [ L ( {s}_{i} , {u}_{i} ) + C ( {s}_{i} , ρ ) ] dt \qquad ( 10 )$$

$$where$$

$$L ( {s}_{i} , {u}_{i} ) = ‖ {s}_{i} \text{?} + {‖ {u}_{i} ‖}_{R}^{2} .$$

$$\text{?} \text{indicates text missing or illegible when filed}$$

Then, a Hamiltonian may be defined as follows:

$$H [ {s}_{i} , {DV}_{i} ( {s}_{i} , ρ , t ) ] = L ( {s}_{i} , {u}_{i} ) + {{DV}_{i} ( {s}_{i} , ρ , t )}^{T} [ F ( {s}_{i} ) + G ( {s}_{i} ) {u}_{i} ] \qquad ( 11 )$$

Next, the following HJB equation may be obtained by substituting the optimal evaluation function into the Hamiltonian as follows:

$$- {\partial }_{t} {V}_{i}^{*} ( {s}_{i} , ρ , t ) - {υΔV}_{i}^{*} ( {s}_{i} , ρ , t ) + H [ {s}_{i} , {DV}_{i}^{*} ( {s}_{i} , ρ , t ) ] = C ( {s}_{i} , ρ ) \qquad ( 12 )$$

Then, the optimal control for each agent may be derived as follows:

$${u}_{i}^{*} ( {s}_{i} ) = - \frac{\text{?}}{2} {R}^{- 1} {g}^{T} ( {s}_{i} ) {DV}_{i}^{*} ( {s}_{i} , ρ , t ) \qquad ( 13 )$$

$$\text{?} \text{indicates text missing or illegible when filed}$$

To obtain the HJB equation in equation (12), the practical probability density function (PDF) (i.e., mass function p) may be required. The mass function may be obtained by solving the FPK equation, where the FPK equation with density constraint may be obtained as follows:

$$\begin{matrix}{\partial }_{t} ρ ( {s}_{i} , t ) = \frac{{\partial }_{t} m ( \tilde{x} , t )}{\frac{\partial m ( \tilde{x} , t )}{\text{?}}} \\ = \frac{υΔ m ( \tilde{x} , t ) + di \text{?} ( m {D}_{p} H [ \tilde{x} , {DV}_{i} ( \tilde{x} , m , t ) ] )}{\frac{\text{?} \frac{\text{?}}{\text{?}}}{\text{?}}} \\ = ( υ Δ ρ ( {s}_{i} , t ) + di \text{?} ( ρ {D}_{p} H [ {s}_{i} , {DV}_{i} ( {s}_{i} , ρ , t ) ] ) ) \\ \frac{{ρ}_{1}^{2} \text{?} - 2 {ρ}_{1} {ρ}_{2} + {ρ}_{1}^{2} \text{?}}{{ρ}_{2} {ρ}_{1}^{2} - {ρ}_{1} {ρ}_{2}^{2}}\end{matrix} \qquad ( 14 )$$

$$\text{?} \text{indicates text missing or illegible when filed}$$

Next, the FPK equation with the optimal cost function may be obtained as follows:

$$( 15 )$$

$${\partial }_{t} ρ ( {s}_{i} , t ) - [ υ Δ ρ ( {s}_{i} , t ) + di \text{?} ( ρ {D}_{p} H [ {s}_{i} , {DV}_{i}^{*} ( {s}_{i} , ρ , t ) ] ) ) ] \frac{{ρ}_{1}^{2} \text{?} - 2 {ρ}_{1} {ρ}_{2} + {ρ}_{1}^{2} \text{?}}{{ρ}_{2} {ρ}_{1}^{2} - {ρ}_{1} {ρ}_{2}^{2}} = 0$$

$$\text{?} \text{indicates text missing or illegible when filed}$$

According to various embodiments of the present disclosure, to obtain the optimal control policy, the coupled HJB-FPK equation may need to be solved in real time. However, the HJB and FPK equations may be multi-dimensional nonlinear PDEs whose solution may be difficult to achieve with state and density constraints. Therefore, in the present disclosure, the barrier-actor-critic-mass based NNs may be developed to learn the solution of coupled HJB-FPK equations.

According to various embodiments of the present disclosure, a method for decentralized optimal control for a large-scale multi-agent system is described hereinafter.

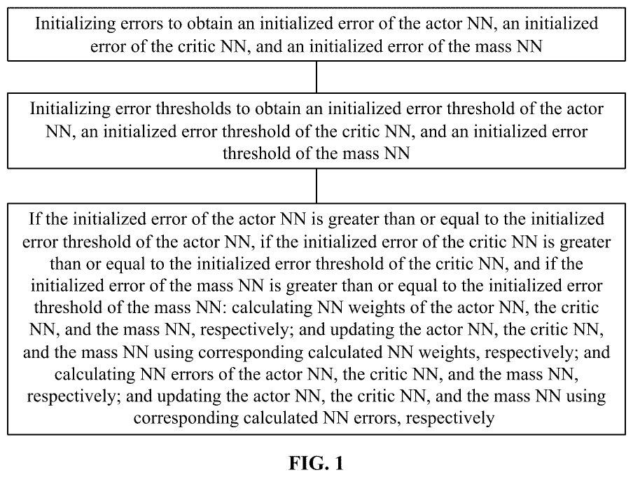

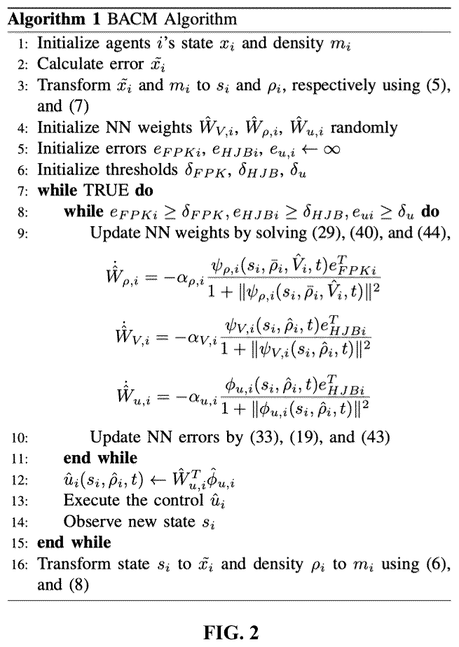

FIG. 1 depicts a flowchart of an exemplary method for decentralized optimal control for a large-scale multi-agent system according to various disclosed embodiments of the present disclosure. FIG. 2 depicts an exemplary BACM algorithm according to various disclosed embodiments of the present disclosure. FIG. 3 depicts an exemplary structure of a barrier-actor-critic-mass system according to various disclosed embodiments of the present disclosure.

The large-scale multi-agent system includes multiple agents; and each agent includes three neural networks (NNs) including an actor NN, a critic NN, and a mass NN. Referring to FIGS. 1-3, the method includes initializing errors to obtain an initialized error of the actor NN, an initialized error of the critic NN, and an initialized error of the mass NN; initializing error thresholds to obtain an initialized error threshold of the actor NN, an initialized error threshold of the critic NN, and an initialized error threshold of the mass NN; if the initialized error of the actor NN is greater than or equal to the initialized error threshold of the actor NN, if the initialized error of the critic NN is greater than or equal to the initialized error threshold of the critic NN, and if the initialized error of the mass NN is greater than or equal to the initialized error threshold of the mass NN: calculating NN weights of the actor NN, the critic NN, and the mass NN, respectively; and updating the actor NN, the critic NN, and the mass NN using corresponding calculated NN weights, respectively; and calculating NN errors of the actor NN, the critic NN, and the mass NN, respectively; and updating the actor NN, the critic NN, and the mass NN using corresponding calculated NN errors, respectively.

In one embodiment, the method further includes, if the initialized error of the actor NN is less than the initialized error threshold of the actor NN, obtaining previous calculated NN weights of the actor NN; or if the initialized error of the critic NN is less than the initialized error threshold of the critic NN, obtaining previous calculated NN weights of the critic NN; or if the initialized error of the mass NN is less than the initialized error threshold of the mass NN, obtaining previous calculated NN weights of the mass NN.

In one embodiment, the method further includes using the previous calculated NN weights of the actor NN to calculate a control; and executing the calculated control.

In one embodiment, the method further includes, before initializing the errors, initializing a state and a density of the agent, where the state of the agent includes a position and a velocity; and calculating an error of the agent using the state of the agent and a predefined trajectory.

In one embodiment, the method further includes, before initializing the errors and after calculating the error of the agent, performing a barrier-function based system transformation on the error and the density of the agent to obtain to a transformed error state and a transformed density state, respectively.

In one embodiment, the transformed error state and the transformed density state are configured to calculate corresponding NN weights and errors.

In one embodiment, the method further includes, before initializing the errors, randomly initializing the NN weights of the actor NN, the critic NN, and the mass NN.

In one embodiment, the critic NN is configured to estimate a cost function; and the mass NN is configured to estimate a probability density function.

In one embodiment, the agent includes an unmanned aerial vehicle.

In one embodiment, referring to FIG. 2, there may be no need for using two levels of while-loops; the outside loop may be only for the purpose of debugging; and optionally, lines 7 and 15 may be removed or omitted.

According to various embodiments of the present disclosure, the barrier-actor-critic-mass algorithm is described hereinafter. Referring to FIGS. 1-3, in the BACM, each agent may maintain three neural networks (NN). The actor NN may approximate the optimal control policy, the critic NN may approximate the optimal evaluation function and the mass NN may estimate the density of the entire population. Meanwhile, the barrier function may be applied into three NNs to ensure both tracking error and density constraints being satisfied during the learning process.

According to various embodiments of the present disclosure, critic learning is described in the following. The optimal value function may be represented as follows:

$$\text{?} ( {s}_{i} , ρ , t ) = {W}_{V , i}^{T} {ϕ}_{V , i} + {ε}_{V , i} \qquad ( 16 )$$

$$\text{?} \text{indicates text missing or illegible when filed}$$

where W_{v,i} may be an ideal critic NN weight and ∅_{v,i} may be the critic NN activation function. In addition, e may represent the reconstruction error of critic neural network. Next, the optimal cost function may be approximated as follows:

$${\hat{V}}_{i} ( {s}_{i} , {\hat{ρ}}_{i} , t ) = {\hat{W}}_{V , i}^{T} {\hat{ϕ}}_{V , i} \qquad ( 17 )$$

where Ŵ_{V,i} may be the approximated NN weights.

By substituting equation (17) to equation (12), a residual error used to tune the weight of the critic NN may be obtained as follows:

$${e}_{HJBi} = C ( {s}_{i} , {\hat{ρ}}_{i} ) + {\hat{W}}_{V , i}^{T} [ {\partial }_{t} {\hat{ϕ}}_{V , i} + νΔ {\hat{ϕ}}_{V , i} - {\hat{H}}_{W} ] \\ where , \hat{H} = H [ {s}_{i} , {DV}_{i}^{*} ( {s}_{i} , {ρ}_{i} , t ) ] and \hat{H} = {\hat{W}}_{V , i}^{T} {\hat{H}}_{W} . \qquad ( 18 )$$

Next, the equation (18) may be simplified as follows:

$${e}_{HJBi} = C ( {s}_{i} , {\hat{ρ}}_{i} ) + {\hat{W}}_{V , i}^{T} {ψ}_{V , i} ( {s}_{i} , {\hat{ρ}}_{i} , t ) \qquad ( 19 )$$

$$where {ψ}_{V , i} ( {s}_{i} , {\hat{ρ}}_{i} , t ) = [ {\partial }_{t} {\hat{ϕ}}_{V , i} + νΔ {\hat{ϕ}}_{V , i} - {\hat{H}}_{W} ] \qquad ( 20 )$$

By substituting the optimal cost function from equation (16) to equation (12), it may obtain:

$$C ( {s}_{i} , {ρ}_{i} ) + {W}_{V , i}^{T} [ {\partial }_{t} {ϕ}_{V , i} + {νΔϕ}_{V , i} - {H}_{W} ] + {ε}_{HJBi} = 0 \qquad ( 21 )$$

where H=W_{V,i}^{T}H_{W} and ε_{HJBi} may be an error caused by the reconstruction error.

After the simplification, the equation (21) may be written as follows:

$$C ( {s}_{i} , {ρ}_{i} ) + {W}_{V , i}^{T} {ψ}_{V , i} ( {s}_{i} , {ρ}_{i} , t ) + {ε}_{HJBi} = 0 \qquad ( 22 )$$

The approximation error of the coupling function may be derived as follows:

$$\tilde{C} ( {s}_{i} , {\tilde{ρ}}_{i} ) = C ( {s}_{i} , {\tilde{ρ}}_{i} ) - C ( {s}_{i} , {ρ}_{i} ) \qquad ( 23 )$$

By substituting equation (23) to equation (22), it may obtain:

$$C ( {s}_{i} , {\tilde{ρ}}_{i} ) - \tilde{C} ( {s}_{i} , {\tilde{ρ}}_{i} ) + {W}_{V , i}^{T} {ψ}_{V , i} ( {s}_{i} , {ρ}_{i} , t ) + {ε}_{HJBi} = 0 \qquad ( 24 )$$

Next, by substituting equation (24) into equation (19), it may obtain:

$${e}_{HJBi} = \tilde{C} ( {s}_{i} , {\tilde{ρ}}_{i} ) - {W}_{V , i}^{T} {ψ}_{V , i} ( {s}_{i} , {ρ}_{i} , t ) - {ε}_{HJBi} + {\hat{W}}_{V , i}^{T} {ψ}_{V , i} ( {s}_{i} , {\hat{ρ}}_{i} , t ) \qquad ( 25 )$$

Next, the critic NN weight approximation error and HJB equation approximation error may be respectively defined as follows:

$${\hat{W}}_{V , i} = {W}_{V , i} - {\hat{W}}_{V , i} \qquad ( 26 )$$

$${\tilde{ψ}}_{V , i} ( {s}_{i} , {\tilde{ρ}}_{i} , t ) = {ψ}_{V , i} ( {s}_{i} , {ρ}_{i} , t ) - {ψ}_{V , i} ( {s}_{i} , {\hat{ρ}}_{i} , t ) \qquad ( 27 )$$

By substituting equation (26) and equation (27) into equation (25), it may obtain:

$$\begin{matrix}{e}_{HJBi} = \tilde{C} ( {s}_{i} , {\tilde{ρ}}_{i} ) - {W}_{V , i}^{T} ( {\tilde{ψ}}_{V , i} ( {s}_{i} , {\tilde{ρ}}_{i} , t ) + {ψ}_{V , i} ( {s}_{i} , {\hat{ρ}}_{i} , t ) ) + \\ ( {W}_{V , i}^{T} - {\tilde{W}}_{V , i}^{T} ) {ψ}_{V , i} ( {s}_{i} , {\hat{ρ}}_{i} , t ) - {ε}_{HJBi} \\ = \tilde{C} ( {s}_{i} , {\tilde{ρ}}_{i} ) - {W}_{V , i}^{T} {\tilde{ψ}}_{V , i} ( {s}_{i} , {\tilde{ρ}}_{i} , t ) - \\ {\tilde{W}}_{V , i}^{T} {ψ}_{V , i} ( {s}_{i} , {\hat{ρ}}_{i} , t ) - {ε}_{HJBi}\end{matrix} \qquad ( 28 )$$

Next, the update law for critic NN may be obtained by using the gradient descent along with the HJB approximation error as follows:

$${\dot{\hat{W}}}_{V , i} = - {α}_{V , i} \frac{{ψ}_{V , i} ( {s}_{i} , {\hat{ρ}}_{i} , t ) {e}_{HJBi}^{T}}{1 + {‖ {ψ}_{V , i} ( {s}_{i} , {\hat{ρ}}_{i} , t ) ‖}^{2}} \qquad ( 29 )$$

where a_{V,i} may be the learning rate.

According to various embodiments of the present disclosure, mass learning is described as the following. The mass function be represented as follows:

$$ρ ( {s}_{i} , t ) = {W}_{ρ , i}^{T} {ϕ}_{ρ , i} + {ε}_{ρ , i} \qquad ( 30 )$$

where Ŵ_{ρ,i} and ϕ_{ρ,i} may be the ideal mass NN weight and activation function, respectively. ε_{ρ,i} may be the reconstruction error of the mass NN.

Then, the mass distribution may be estimated as follows:

$$\hat{ρ} ( {s}_{i} , {\overline{ρ}}_{i} , t ) = {\hat{W}}_{ρ , i}^{T} {\hat{ϕ}}_{ρ , i} \qquad ( 31 )$$

where Ŵ_{ρ,i} may be the approximated mass NN weight. Moreover, ρ̅ may be the averaged historical density defined as

$$\overline{ρ} = \frac{1}{T} {\int }_{t}^{t - T} ρ d ρ ,$$

and T may be a constant historical window.

The residual error for the mass NN may be defined by substituting equation (31) to equation (15) as follows:

$${e}_{{FPK}_{i}} = {\hat{W}}_{ρ , i}^{T} [ {\partial }_{t} {\hat{ϕ}}_{ρ , i} - [ νΔ {\hat{ϕ}}_{ρ , i} + div ( {\hat{ϕ}}_{ρ , i} {D}_{p} \hat{H} ) ] \frac{{ρ}_{1}^{2} {e}^{- {\overline{ρ}}_{i}} - 2 {ρ}_{1} {ρ}_{2} + {ρ}_{1}^{2} {e}^{{\overline{ρ}}_{i}}}{{ρ}_{2} {ρ}_{1}^{2} - {ρ}_{1} {ρ}_{2}^{2}} ] \qquad ( 32 )$$

$$where \hat{H} = H [ {s}_{i} , {D}_{s} {\hat{ϕ}}_{V , i} ]$$

Equation (32) may be simplified as follows:

$${e}_{FPKi} = {\hat{W}}_{ρ , i}^{T} {ψ}_{ρ , i} ( {s}_{i} , {\overline{ρ}}_{i} , {\hat{V}}_{i} , t ) \qquad ( 33 )$$

$${ψ}_{ρ , i} ( {s}_{i} , ρ {\text{?}}_{i} , {\hat{V}}_{i} , \text{} t ) = [ \text{} {\partial }_{t} {\hat{ϕ}}_{ρ , i} - [ v Δ {\hat{ϕ}}_{ρ , i} + div ( {\hat{ϕ}}_{ρ , i} {D}_{ρ} \hat{H} ) ] \frac{{ρ}_{1}^{2} {e}^{- {ρ}_{i}} \text{?} - 2 {ρ}_{1} {ρ}_{2} + {ρ}_{1}^{2} {e}^{- ρ} \text{?}}{{ρ}_{2} {ρ}_{1}^{2} - {ρ}_{1} {ρ}_{2}^{2}} ] \qquad ( 34 )$$

$$\text{?} \text{indicates text missing or illegible when filed}$$

Next, by substituting the mass function from equation (30) to equation (15), it may obtain:

$${W}_{ρ , i}^{T} [ {\partial }_{t} {ϕ}_{ρ , i} - [ v Δ {ϕ}_{ρ , i} + div ( {ϕ}_{ρ , i} {D}_{ρ} H [ {s}_{i} , {D}_{s} {V}_{i} ( {s}_{i} , {ρ}_{i} , t ) ] ) ] \qquad ( 35 )$$

$$\frac{{ρ}_{1}^{2} {e}^{- {ρ}_{i}} \text{?} - 2 {ρ}_{1} {ρ}_{2} + {ρ}_{1}^{2} {e}^{- {ρ}_{i}} \text{?}}{{ρ}_{2} {ρ}_{1}^{2} - {ρ}_{1} {ρ}_{2}^{2}} ] + {\text{?}}_{FPKi} = 0$$

$$\text{?} \text{indicates text missing or illegible when filed}$$

which may be simplified as follows:

$${W}_{ρ , i}^{T} {ψ}_{ρ , i} ( {s}_{i} , ρ {\text{?}}_{i} , {V}_{i} , t ) + {\text{?}}_{FPKi} = 0 \qquad ( 36 )$$

$$\text{?} \text{indicates text missing or illegible when filed}$$

The mass NN weight approximation error and FPK equation approximation error may be defined as follows:

$${\tilde{W}}_{ρ , i} = {W}_{ρ , i} = {\hat{W}}_{ρ , i} \qquad ( 37 )$$

$$ψ {\text{?}}_{ρ , i} ( {s}_{i} , ρ {\text{?}}_{i} , {\tilde{V}}_{i} , t ) = {ψ}_{ρ , i} ( {s}_{i} , ρ {\text{?}}_{i} , {V}_{i} , t ) - {ψ}_{ρ , i} ( {s}_{i} , ρ {\text{?}}_{i} , {\hat{V}}_{i} , t ) \qquad ( 38 )$$

$$\text{?} \text{indicates text missing or illegible when filed}$$

Next, be substituting equation (36) into equation (33), it may obtain:

$${\text{?}}_{FPKi} = - W {\text{?}}_{ρ , i}^{T} {ψ}_{ρ , i} ( {s}_{i} , {\overline{ρ}}_{i} , {\hat{V}}_{i} , t ) - {W}_{ρ , i}^{T} ψ {\text{?}}_{ρ , i} ( {s}_{i} , ρ {\text{?}}_{i} , V {\text{?}}_{i} , t ) = {\text{?}}_{FPKi} \qquad ( 39 )$$

$$\text{?} \text{indicates text missing or illegible when filed}$$

Then, by applying the gradient descent along with FPK estimation error, the update law for mass NN may be generated as follows:

$${\dot{\hat{W}}}_{ρ , i} = {α}_{ρ . i} \frac{{ψ}_{ρ , i} ( {s}_{i} , {\overline{ρ}}_{i} , {\hat{V}}_{i} , t ) {e}_{FPKi}^{T}}{1 + {‖ {ψ}_{ρ , i} ( {s}_{i} , {\overline{ρ}}_{i} , {\hat{V}}_{i} , t ) ‖}^{2}} \qquad ( 40 )$$

where α_{ρ,i} may be the mass NN learning rate.

According to various embodiments of the present disclosure, actor learning is described as the following. The optimal control may be represented as follows:

$${u}_{i} ( {s}_{i} , ρ , t ) = {W}_{u , i}^{T} {ϕ}_{u , i} + {ε}_{u , i} \qquad ( 41 )$$

where W_{u,i} and ϕ_{u,i} may be the ideal actor NN weight and activation function, respectively. ε_{u,i} may be the reconstruction error of the Actor NN.

Then, the optimal control may be estimated as follows:

$${\hat{u}}_{i} ( {s}_{i} , {\hat{ρ}}_{i} , t ) = {\hat{W}}_{u , i}^{T} {\hat{ϕ}}_{u , i} \qquad ( 42 )$$

where Ŵ_{u,i} is the approximated actor NN weight.

The residual error after substituting equation (42) into equation (13) may be represented as follows:

$${e}_{u , i} = {\hat{W}}_{u , i}^{T} {\hat{ϕ}}_{u , i} + \frac{1}{2} {R}^{- 1} {g}^{T} ( {s}_{i} ) {D}_{s} {\hat{V}}_{i} ( {s}_{i} , {\hat{ρ}}_{i} , t ) \qquad ( 43 )$$

Furthermore, the update law for actor NN may be designed as follows:

$${W}_{u , i} \text{?} = - {α}_{u , i} \frac{{ϕ}_{u , i} ( {s}_{i} , {\hat{ρ}}_{i} , t ) {e}_{ui}^{T}}{1 + {‖ {ϕ}_{u , i} ( {s}_{i} , {\hat{ρ}}_{i} , t ) ‖}^{2}} \qquad ( 44 )$$

$$\text{?} \text{indicates text missing or illegible when filed}$$

The designed BACM algorithm has been implemented into the large-scale multi-UAV (unmanned aerial vehicle) system to address the decentralized mean field based optimal tracking control problem. In one embodiment, a total of 3000 agents (e.g., UAV) may be deployed with system dynamics under physical limitation and uncertain environment. A reference trajectory may have been given ahead of the mission planning. The goal of each agent may be to track the reference trajectory while avoiding the obstacle during the mission. Therefore, the movements of all agents may be limited to a fixed area with specific boundary and density constraint. The initial positions of all agents may be generated randomly following a normal distribution with mean 0.5 and variance 0.16. The initial velocities of all agents may be set to zero. In one embodiment, the reference trajectory may be given as follows:

$${x}_{r} ( t ) = [ \begin{matrix}0.2 sin ( 2 t ) + 0.002 {t}^{2} + 0.5 \\ 0.2 t \\ 0.2 cos ( 2 t ) + 0.004 t \\ 0.2\end{matrix} ]$$

In one embodiment, the agent intrinsic dynamics may be given as follows:

$${f}^{′} ( x ) = [ \begin{matrix}{x}_{2} - {x}_{1} \\ {x}_{4} - {x}_{3} \\ \frac{{x}_{2}}{2} [ ( {cos ( 2 {x}_{1} + 2 )}^{2} - 1 ) ] - \frac{{x}_{1}}{2} \\ \frac{{x}_{4}}{2} [ ( {cos ( 2 {x}_{3} + 2 )}^{2} - 1 ) ] - \frac{{x}_{3}}{2}\end{matrix} ]$$

$${g}^{′} ( x ) = [ \begin{matrix}0 \\ 0 \\ cos ( 2 {x}_{1} ) + 2 \\ cos ( 2 {x}_{3} ) + 2\end{matrix} ]$$

The non-negative parameter v may be selected as 0.02. The mean field cost function may be selected as C(sᵢ, m)=∥sᵢ− [symbol] (ρ)∥, which represents the difference between current tracking error of the agent i and current average tracking error of the whole population. In addition, the state and density constraints may be considered as follows:

$$[ \begin{matrix}{l}_{\tilde{x} , i} \\ {u}_{\tilde{x} , i}\end{matrix} ] = [ \begin{matrix}{x}_{r} ( t ) + 1 \\ - ( {x}_{r} ( t ) + 1 )\end{matrix} ]$$

where l_{\tilde{x},i} and u_{\tilde{x},i} may be the lower and upper bound of the state constraint, respectively.

Furthermore, the lower and upper bound of the density constraint may be defined as follows:

$$[ \begin{matrix}{ρ}_{1} \\ {ρ}_{2}\end{matrix} ] = [ \begin{matrix}0.2 \\ 1\end{matrix} ]$$

where ρ(s)=1 may denote that the tracking error of all agents are same.

The barrier function-based system transformation may have been employed for state constraint. The new dynamics of the transformed system may be given as follows:

$$F ( {s}_{i} ) = f ( {B}_{i}^{- 1} ( {s}_{i} ) ) \frac{{u}_{\overline{x} , i}^{2} {e}^{- {s}_{i}} - 2 {l}_{\overline{x} , i} {u}_{\overline{x} , i} + {l}_{\overline{x} , i}^{2} {e}^{{s}_{i}}}{{u}_{\overline{x} , i} {l}_{\overline{x} , i}^{2} - {l}_{\overline{x} , i} {u}_{\overline{x} , i}^{2}} \qquad ( 45 )$$

$$G ( {s}_{i} ) = g ( {B}_{i}^{- 1} ( {s}_{i} ) ) \frac{{u}_{\overline{x} , i}^{2} {e}^{- {s}_{i}} - 2 {l}_{\overline{x} , i} {u}_{\overline{x} , i} + {l}_{\overline{x} , i}^{2} {e}^{{s}_{i}}}{{u}_{\overline{x} , i} {l}_{\overline{x} , i}^{2} - {l}_{\overline{x} , i} {u}_{\overline{x} , i}^{2}} \qquad ( 46 )$$

$$where f ( {B}_{i}^{- 1} ( {s}_{i} ) ) = {f}^{′} ( x ) - ( {dx}_{r} / dt ) and g ( {B}_{i}^{- 1} ( {s}_{i} ) ) = {g}^{′} ( x ) .$$

In one embodiment, the coefficients to evaluate the cost of actions and tracking errors may be selected as R=1, and Q=1. The learning rate of the neural network may be defined as α_{u,i}=2×10⁻⁴, α_{V,i}=2×10⁻⁶, α_{ρ,i}=1×10⁻³. Furthermore, the thresholds may be defined as δᵤ=1×10⁻³, δ_{FPK}=1×10⁻³, and δ_{HJB}=1×10⁻⁴.

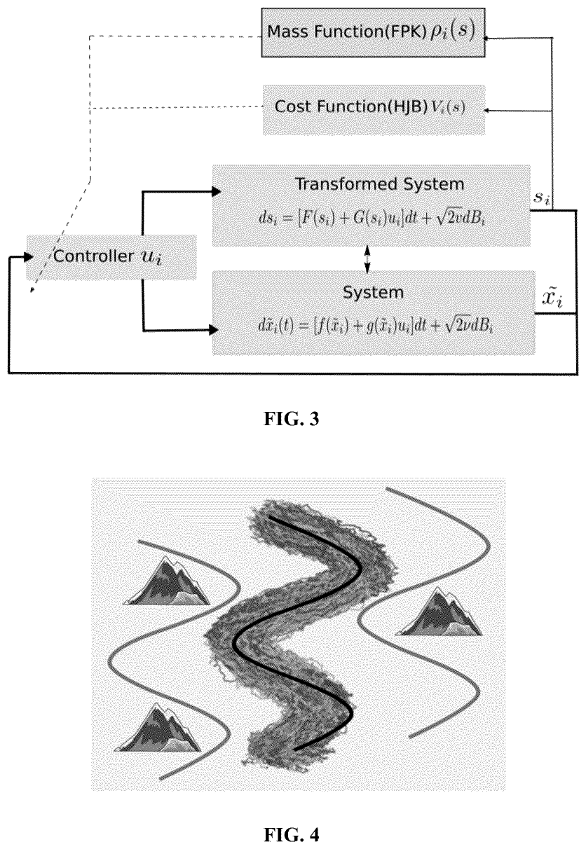

According to various embodiments of the present disclosure, the overall performance schematic of developed BACM based decentralized optimal tracking control is shown in FIG. 4. Referring to FIG. 4, the black curve may mark the reference trajectory and grey curves may represent the boundary constraints. It should be noted that the developed algorithm may force all the agents to track the reference trajectory while satisfying the given state constraints (i.e., boundary).

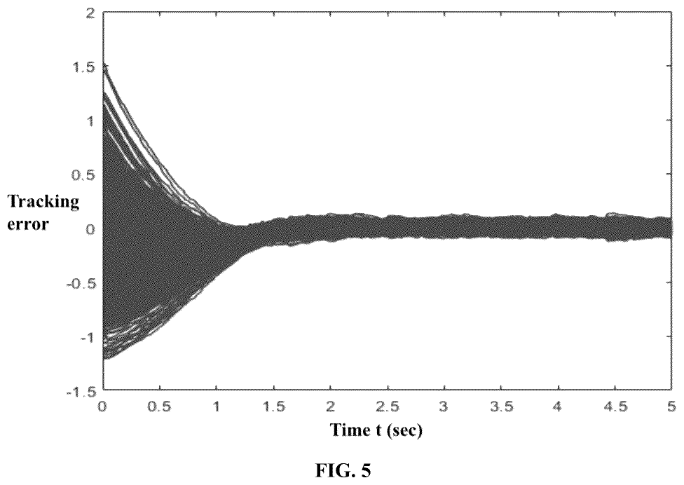

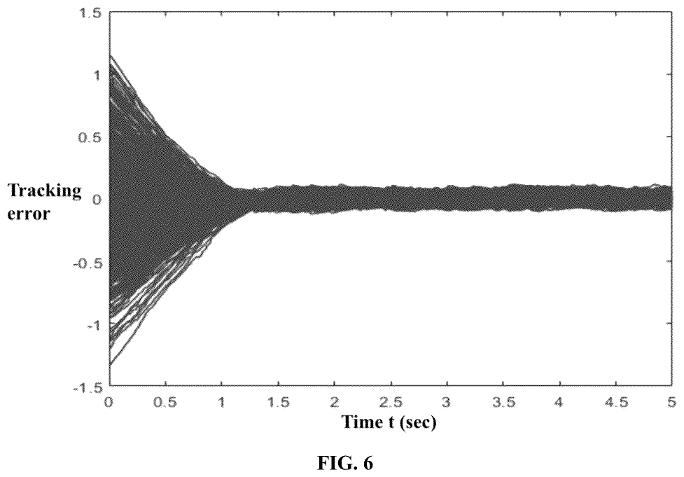

The tracking errors of all agents has been analyzed in various embodiments of the present disclosure. FIG. 5 depicts an exemplary tracking error plot of all agents in an x axis according to various disclosed embodiments of the present disclosure. FIG. 6 depicts an exemplary tracking error plot of all agents in a y axis according to various disclosed embodiments of the present disclosure. FIGS. 5-6 illustrate the tracking errors of all agents in the x-axis and y-axis, respectively. Both figures show that the tracking errors may converge to near zero along with time, which may indicate that the designed algorithm may track the reference trajectory in real time.

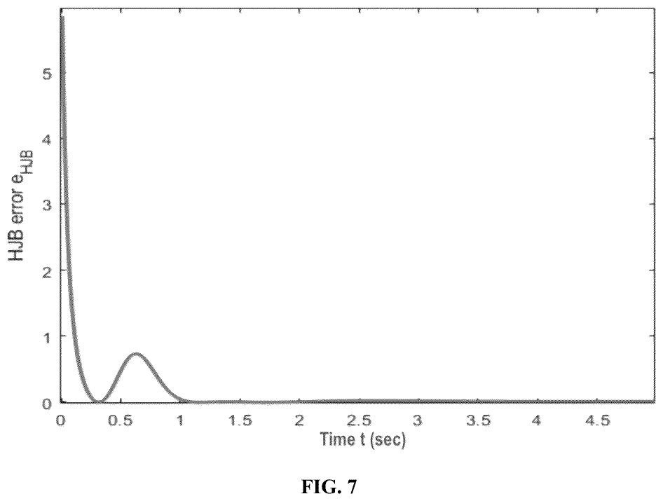

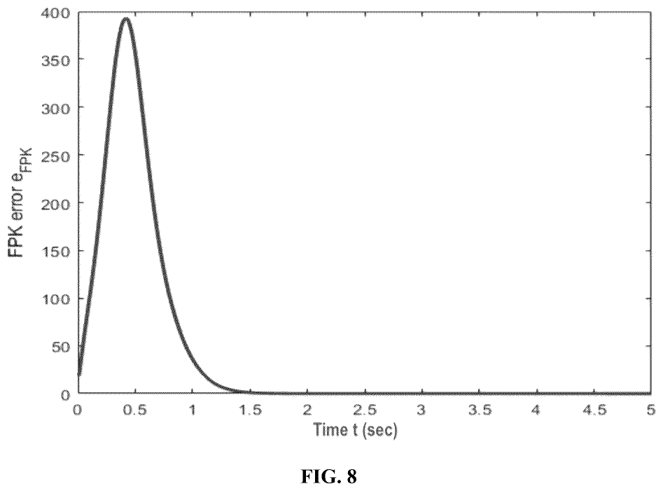

According to various embodiments of the present disclosure, the neural networks performance may be demonstrated by analyzing the HJB equation error along with the FPK equation error of agents. FIG. 7 depicts an exemplary HJB equation error plot according to various disclosed embodiments of the present disclosure. FIG. 8 depicts an exemplary FPK equation error plot according to various disclosed embodiments of the present disclosure. Without loss of generality, the optimality for, for example, agent 1, may be evaluated. Referring to FIGS. 7-8, the mean field equations error for agent 1 may converge to near zero, which may indicate that the solution of the HJB-FPK coupled equation system may be successfully approximated, such that the e-Nash equilibrium may have been reached.

According to various embodiments of the present disclosure, the BACM framework may have been developed based on mean field game theory. The decentralized optimal control for LS-MAS may have been obtained by solving the coupled HJB-FPK equations under the state and density constraints that is ensured through appropriate barrier functions. Three neural networks may be employed to solve the barrier function based mean field game, where the actor NN is for learning optimal control, the critic NN is for estimating optimal cost function, and the mass NN is for approximating the LS-MAS's probability density function (i.e., mass). Furthermore, a series of numerical simulations may have demonstrated the effectiveness of the developed method in embodiments of the present disclosure.

Various embodiments of the present disclosure further provide a device for decentralized optimal control for a large-scale multi-agent system. The large-scale multi-agent system includes multiple agents. Each agent includes three neural networks (NNs) including an actor NN, a critic NN, and a mass NN. The device includes a memory, configured to store program instructions for performing a method for decentralized optimal control for the large-scale multi-agent system; and a processor, coupled with the memory and, when executing the program instructions, configured for: initializing errors to obtain an initialized error of the actor NN, an initialized error of the critic NN, and an initialized error of the mass NN; initializing error thresholds to obtain an initialized error threshold of the actor NN, an initialized error threshold of the critic NN, and an initialized error threshold of the mass NN; if the initialized error of the actor NN is greater than or equal to the initialized error threshold of the actor NN, if the initialized error of the critic NN is greater than or equal to the initialized error threshold of the critic NN, and if the initialized error of the mass NN is greater than or equal to the initialized error threshold of the mass NN: calculating NN weights of the actor NN, the critic NN, and the mass NN, respectively; and updating the actor NN, the critic NN, and the mass NN using corresponding calculated NN weights, respectively; and calculating NN errors of the actor NN, the critic NN, and the mass NN, respectively; and updating the actor NN, the critic NN, and the mass NN using corresponding calculated NN errors, respectively.

Various embodiments of the present disclosure further provide a non-transitory computer-readable storage medium, containing program instructions for, when being executed by a processor, performing a method for decentralized optimal control for a large-scale multi-agent system. The large-scale multi-agent system includes multiple agents. Each agent includes three neural networks (NNs) including an actor NN, a critic NN, and a mass NN. The method includes initializing errors to obtain an initialized error of the actor NN, an initialized error of the critic NN, and an initialized error of the mass NN; initializing error thresholds to obtain an initialized error threshold of the actor NN, an initialized error threshold of the critic NN, and an initialized error threshold of the mass NN; if the initialized error of the actor NN is greater than or equal to the initialized error threshold of the actor NN, if the initialized error of the critic NN is greater than or equal to the initialized error threshold of the critic NN, and if the initialized error of the mass NN is greater than or equal to the initialized error threshold of the mass NN: calculating NN weights of the actor NN, the critic NN, and the mass NN, respectively; and updating the actor NN, the critic NN, and the mass NN using corresponding calculated NN weights, respectively; and calculating NN errors of the actor NN, the critic NN, and the mass NN, respectively; and updating the actor NN, the critic NN, and the mass NN using corresponding calculated NN errors, respectively.

The embodiments disclosed herein may be exemplary only. Other applications, advantages, alternations, modifications, or equivalents to the disclosed embodiments may be obvious to those skilled in the art and be intended to be encompassed within the scope of the present disclosure.

What is claimed is:

1. A method for decentralized optimal control for a large-scale multi-agent system, the large-scale multi-agent system including multiple agents each including three neural networks (NNs) including an actor NN, a critic NN, and a mass NN, the method comprising:
initializing errors to obtain an initialized error of the actor NN, an initialized error of the critic NN, and an initialized error of the mass NN;
initializing error thresholds to obtain an initialized error threshold of the actor NN, an initialized error threshold of the critic NN, and an initialized error threshold of the mass NN; and
if the initialized error of the actor NN is greater than or equal to the initialized error threshold of the actor NN, if the initialized error of the critic NN is greater than or equal to the initialized error threshold of the critic NN, and if the initialized error of the mass NN is greater than or equal to the initialized error threshold of the mass NN:
calculating NN weights of the actor NN, the critic NN, and the mass NN, respectively; and updating the actor NN, the critic NN, and the mass NN using corresponding calculated NN weights, respectively; and
calculating NN errors of the actor NN, the critic NN, and the mass NN, respectively; and updating the actor NN, the critic NN, and the mass NN using corresponding calculated NN errors, respectively.

2. The method according to claim 1, further including:
if the initialized error of the actor NN is less than the initialized error threshold of the actor NN, obtaining previous calculated NN weights of the actor NN; or
if the initialized error of the critic NN is less than the initialized error threshold of the critic NN, obtaining previous calculated NN weights of the critic NN; or
if the initialized error of the mass NN is less than the initialized error threshold of the mass NN, obtaining previous calculated NN weights of the mass NN.

3. The method according to claim 2, further including:
using the previous calculated NN weights of the actor NN to calculate a control; and
executing the calculated control.

4. The method according to claim 1, wherein before initializing the errors, the method further includes:
initializing a state and a density of the agent, wherein the state of the agent includes a position and a velocity; and
calculating an error of the agent using the state of the agent and a predefined trajectory.

5. The method according to claim 4, wherein before initializing the errors and after calculating the error of the agent, the method further includes:
performing a barrier-function based system transformation on the error and the density of the agent to obtain to a transformed error state and a transformed density state, respectively.

6. The method according to claim 5, wherein:
the transformed error state and the transformed density state are configured to calculate corresponding NN weights and errors.

7. The method according to claim 1, wherein before initializing the errors, the method further includes:
randomly initializing the NN weights of the actor NN, the critic NN, and the mass NN.

8. The method according to claim 1, wherein:
the critic NN is configured to estimate a cost function; and
the mass NN is configured to estimate a probability density function.

9. The method according to claim 1, wherein:
the agent includes an unmanned aerial vehicle.

10. A device for decentralized optimal control for a large-scale multi-agent system, the large-scale multi-agent system including multiple agents each including three neural networks (NNs) including an actor NN, a critic NN, and a mass NN, the device comprising:
a memory, configured to store program instructions for performing a method for decentralized optimal control for the large-scale multi-agent system; and
a processor, coupled with the memory and, when executing the program instructions, configured for:
initializing errors to obtain an initialized error of the actor NN, an initialized error of the critic NN, and an initialized error of the mass NN;
initializing error thresholds to obtain an initialized error threshold of the actor NN, an initialized error threshold of the critic NN, and an initialized error threshold of the mass NN;
if the initialized error of the actor NN is greater than or equal to the initialized error threshold of the actor NN, if the initialized error of the critic NN is greater than or equal to the initialized error threshold of the critic NN, and if the initialized error of the mass NN is greater than or equal to the initialized error threshold of the mass NN:
calculating NN weights of the actor NN, the critic NN, and the mass NN, respectively; and updating the actor NN, the critic NN, and the mass NN using corresponding calculated NN weights, respectively; and
calculating NN errors of the actor NN, the critic NN, and the mass NN, respectively; and updating the actor NN, the critic NN, and the mass NN using corresponding calculated NN errors, respectively.

11. The device according to claim 10, wherein the processor is further configured for:
if the initialized error of the actor NN is less than the initialized error threshold of the actor NN, obtaining previous calculated NN weights of the actor NN; or
if the initialized error of the critic NN is less than the initialized error threshold of the critic NN, obtaining previous calculated NN weights of the critic NN; or
if the initialized error of the mass NN is less than the initialized error threshold of the mass NN, obtaining previous calculated NN weights of the mass NN.

12. The device according to claim 11, wherein the processor is further configured for:
using the previous calculated NN weights of the actor NN to calculate a control; and
executing the calculated control.

13. The device according to claim 10, wherein before initializing the errors, the processor is further configured for:
initializing a state and a density of the agent, wherein the state of the agent includes a position and a velocity; and
calculating an error of the agent using the state of the agent and a predefined trajectory.

14. The device according to claim 13, wherein before initializing the errors and after calculating the error of the agent, the processor is further configured for:
performing a barrier-function based system transformation on the error and the density of the agent to obtain to a transformed error state and a transformed density state, respectively.

15. The device according to claim 14, wherein:
the transformed error state and the transformed density state are configured to calculate corresponding NN weights and errors.

16. The device according to claim 10, wherein before initializing the errors, the processor is further configured for:
randomly initializing the NN weights of the actor NN, the critic NN, and the mass NN.

17. A non-transitory computer-readable storage medium, containing program instructions for, when being executed by a processor, performing a method for decentralized optimal control for a large-scale multi-agent system which includes multiple agents each including three neural networks (NNs) including an actor NN, a critic NN, and a mass NN, the method comprising:
initializing errors to obtain an initialized error of the actor NN, an initialized error of the critic NN, and an initialized error of the mass NN;
initializing error thresholds to obtain an initialized error threshold of the actor NN, an initialized error threshold of the critic NN, and an initialized error threshold of the mass NN;
if the initialized error of the actor NN is greater than or equal to the initialized error threshold of the actor NN, if the initialized error of the critic NN is greater than or equal to the initialized error threshold of the critic NN, and if the initialized error of the mass NN is greater than or equal to the initialized error threshold of the mass NN:
calculating NN weights of the actor NN, the critic NN, and the mass NN, respectively; and updating the actor NN, the critic NN, and the mass NN using corresponding calculated NN weights, respectively; and
calculating NN errors of the actor NN, the critic NN, and the mass NN, respectively; and updating the actor NN, the critic NN, and the mass NN using corresponding calculated NN errors, respectively.

18. The storage medium according to claim 17, wherein the method further includes:
if the initialized error of the actor NN is less than the initialized error threshold of the actor NN, obtaining previous calculated NN weights of the actor NN; or
if the initialized error of the critic NN is less than the initialized error threshold of the critic NN, obtaining previous calculated NN weights of the critic NN; or
if the initialized error of the mass NN is less than the initialized error threshold of the mass NN, obtaining previous calculated NN weights of the mass NN.

19. The storage medium according to claim 18, wherein the method further includes:
using the previous calculated NN weights of the actor NN to calculate a control; and
executing the calculated control.

20. The storage medium according to claim 17, wherein before initializing the errors, the method further includes:
initializing a state and a density of the agent, wherein the state of the agent includes a position and a velocity; and
calculating an error of the agent using the state of the agent and a predefined trajectory.
